(19) United States
(12) Patent Application Publication
(10) Pub. No.: US 2008/0161965 A1
(43) Pub. Date: Jul. 3, 2008

(54) COMPUTER-AIDED MANUFACTURING INTEGRATED MACHINE PROBING

(76) Inventors: Luke D. Haines, Grand Prairie, TX (US); David K. George, Colleyville, TX (US)

Correspondence Address: WILLIAMS, MORGAN & AMERSON, 10333 RICHMOND, SUITE 1100, HOUSTON, TX, 77042, US

(21) Appl. No.: 11/957,131

(22) Filed: Dec. 14, 2007

Related U.S. Application Data
(60) Provisional application No. 60/882,060, filed on Dec. 27, 2006.

(51) Int. Cl. G06F 19/00

(52) U.S. Cl. 700/182

(57) ABSTRACT

The present invention pertains to computer-aided manufacturing and, more particularly, to machine probing in computer-aided manufacturing. The invention comprises a method and apparatus employing an automated, integrated approach to generating add-on control software for a CNC tool.

The earlier effective filing date of co-pending U.S. Provisional Application Ser. No. 60/882,060; entitled, “COMPUTER-AIDED MANUFACTURING INTEGRATED MACHINE PROBING”; filed Dec. 27, 2006, filed in the name of the inventors Luke D. Haines and David K. George (Atty Docket 2063.013590/LMMFC Docket No. VS-00820) is hereby claimed. This application is also hereby incorporated by reference for all purposes as if set forth herein verbatim.

### BACKGROUND OF THE INVENTION

1. Field of the Invention

The present invention pertains to computer-aided manufacturing and, more particularly, to machine probing in computer-aided manufacturing.

2. Description of the Related Art

Many manufacturing processes employ computer numerical code (“CNC”) tools that include embedded numerical control (“NC”) controllers. Tool manufacturers who make and sell CNC tools sometimes offer add-on equipment, i.e., pieces of equipment for which the customer can pay extra to have “added-on” to the CNC tool. For example, a milling machine—a type of CNC tool—may be used with a touch sensor add-on, like a probe. The CNC tool and the hardware add-on, when used, then operate under the programmed control of the NC controller.

In a computer-aided manufacturing (“CAM”) environment, a single CAM workstation might be used to direct several CNC tools in their operation. The CAM workstation generally comprises a computing apparatus of some kind programmed with a CAM application and a postprocessor. A user enters directions for the programmed task through the CAM application. The postprocessor then takes the directions and converts, or “translates”, the directions into the commands understood by the particular CNC tools programmed from the CAM workstation. The embedded NC controllers then control their respective CNC tools in accordance with the directives emanating from the CAM workstation through the postprocessor.

One problem in these situations is that the add-on equipment does not automatically receive directions in this manner. Because the hardware is “add-on”, it is not a part of the directives issued by the CAM workstation. This causes a number of difficulties. To program the CNC tool for its hardware add-on, the code must be handwritten, hand tested, and hand entered. This is very time consuming, and is different for every CNC tool. It can also be very complicated for multi-axis CNC tool. Still other difficulties abound from this circumstance.

The present invention is directed to resolving, or at least reducing, one or all of the problems mentioned above.

### SUMMARY OF THE INVENTION

The present invention pertains to computer-aided manufacturing and, more particularly, to machine probing in computer-aided manufacturing. The invention comprises a method and apparatus employing an automated, integrated approach to generating add-on control software for a CNC tool.

### BRIEF DESCRIPTION OF THE DRAWINGS

The invention may be understood by reference to the following description taken in conjunction with the accompanying drawings, in which like reference numerals identify like elements, and in which:

FIG. 1 depicts a manufacturing system in accordance with one aspect of the present invention;

FIG. 2A-FIG. 2B show selected portions of the hardware and software architecture of the NC controller and the computing apparatus, respectively, first shown in FIG. 1;

FIG. 3 depicts one particular embodiment of FIG. 1;

FIG. 4 presents an opening dialog box as might be used in the graphical programming in accordance with one particular aspect of the invention in one particular embodiment;

FIG. 5-FIG. 18 present alternative program definition boxes prompted by the user selections in the opening dialog box in FIG. 4;

FIG. 19 depicts a particular work piece on which the operations defined in FIG. 5-FIG. 18 are intended to operate;

FIG. 20 presents the “Probing” tabbed menu for the program definition box first shown in FIG. 15. and

FIG. 21 illustrates one embodiment of a method in accordance with the present invention.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIG. 1 illustrates a manufacturing system 100 in accordance with one aspect of the present invention. The manufacturing system 100 includes a computer numerical code (“CNC”) tool 103 with an embedded a numerical control (“NC”) controller 106 on which resides at least one macro 107. The CNC tool 103 also includes a hardware add-on 108. The NC controller 106 interfaces with a computing apparatus 109 on which resides a computer-aided manufacturing application 112 and a post-processor 115. The NC controller 106 and the computing apparatus interface over a communications link 118. The communications link 118 may be any suitable link known to the art, e.g., a cable or a wireless link.

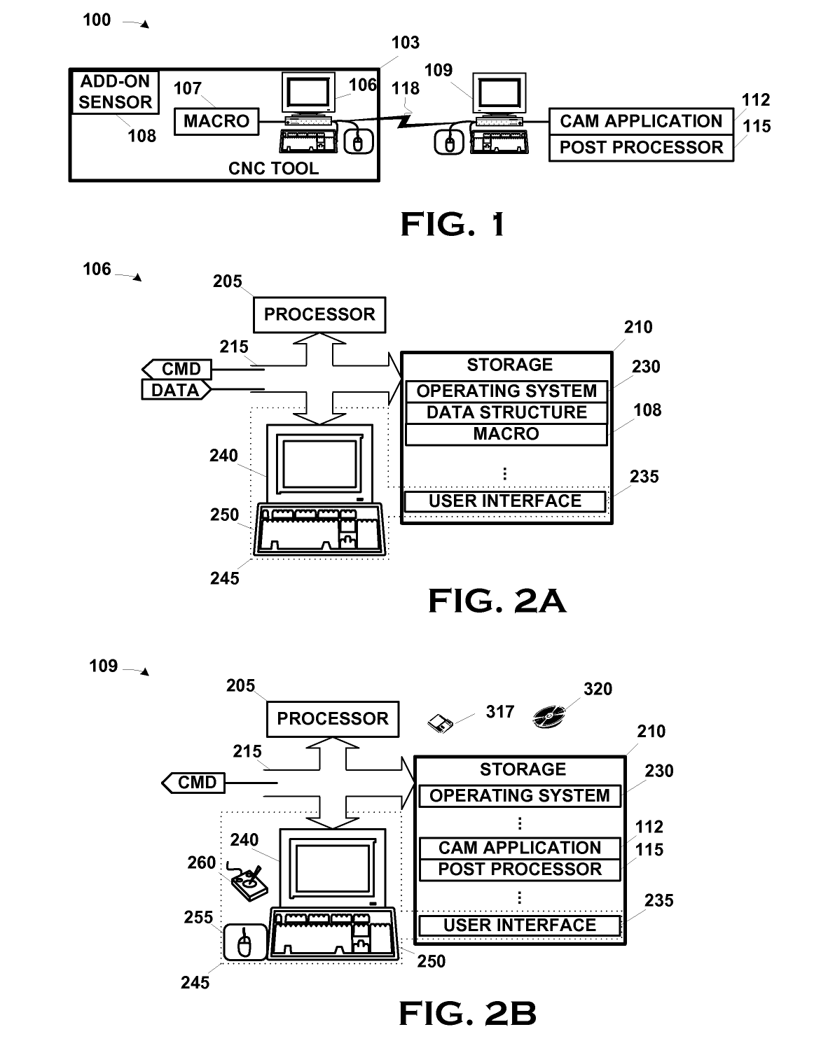

In one aspect, the present invention is a software-implemented method. FIG. 2A-FIG. 2B show selected portions of the hardware and software architecture of the NC controller 106 and the computing apparatus 109, respectively. Each includes a processor 205 communicating with storage 210 over a bus system 215. The storage 210 may include a hard disk and/or random access memory (“RAM”) and/or removable storage such as a floppy magnetic disk 217 and an optical disk 220, shown in FIG. 2B.

The storage 210 is also encoded with an operating system 230, user interface software 235. The user interface software 235, in conjunction with a display 240, implements a user interface 245. The user interface 245 may include peripheral I/O devices such as a keypad or keyboard 250, a mouse 255, or a joystick 260 as shown in FIG. 2B. The processor 205 runs under the control of the operating system 230, which may be practically any operating system known to the art.

The storages 210 are also encoded with the macro 107, the CAM application 112, and the post processor 115, as shown. The CAM application 112 is invoked by its respective operating system 230 upon power up, reset, or both, depending on the implementation of the operating system 230. The CAM application 112, when invoked, performs the method of the present invention. The user may alternatively invoke the CAM application 112 in conventional fashion through the user interface 245.

It is apparent from the discussion herein that some portions of the detailed descriptions herein are consequently presented in terms of a software-implemented process involving symbolic representations of operations on data bits within a memory in a computing system or a computing device. For example, in the illustrated embodiment, the macro 107, the CAM application 112, and the post processor 115 are software-implemented. The descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software-implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

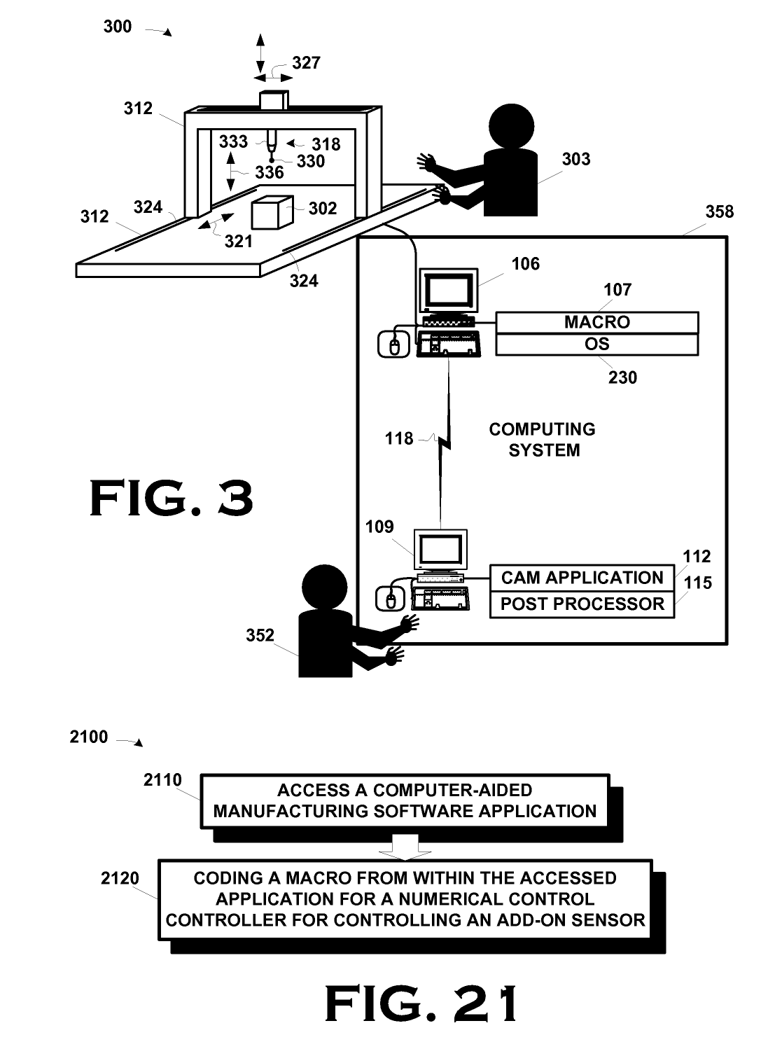

In the illustrated embodiment the CAM application 112 and the macro 107 are, as the names imply, an “application” and a “macro”, respectively. This aspect of the software architecture is an implementation-specific feature. As is discussed more fully below with reference to FIG. 3, some aspects of the present invention are implemented using commercially available products off-the-shelf. These products implement the CAM application 112 and the macro 107 as an application and a macro, respectively. However, this is not necessary to the practice of the invention, and the functionalities they embody may be presented in other types of software components.

The CNC tool 103 operates under the direction of the NC controller 106 in accordance with conventional fashion. More particularly, the NC controller 106 executes macros (not shown) to perform actions that are referred to as “events”. The nature of these events and the nature of the macros will be implementation specific. For example, a CNC tool 103 may perform a milling operation or a metrology operation, and the events on the tool will vary accordingly. Similarly, some tools are single axis while others have multiple axes, and they process accordingly. Still further, various implementations may code the macros in different languages or different formats depending on a host of factors that will be apparent to those skilled in the art.

In the illustrated embodiment, the CNC tool 103 is a probing tool such as the milling tool 300, conceptually illustrated in FIG. 3. CNC tools such as the milling tool 300 are known and are commercially available. In the illustrated embodiment, the milling tool 300 is a Mazak Integrex CNC tool available from Mazak Corporation, who may be contacted at 8025 Production Drive, P.O. Box 970, Florence, Ky. 41042, telephone (859) 342-1700, telefax (859) 342-1865. Additional information is available from their site on the World Wide Web of the Internet at http://www.mazakusa.com/. Accordingly, only those portions of the milling tool 300 relevant to the present invention are shown for the sake of clarity and so as not to obscure the present invention. Those in the art having the benefit of the present disclosure will appreciate that the milling tool 300 includes additional features and functionalities over and above those shown.

Generally, a simple milling tool 300 may include a gantry 312 mounted on a table 315 that is, in turn, mounted in a manner not shown to dampen vibration, etc. A probe 318 is suspended from the gantry 312. The probe 318 is a “touch sensor” that is an “add-on” sensor. Note that the invention is not necessarily limited to sensors in all embodiments, and may include other hardware in alternative embodiments.

The probe 318 travels in the direction indicated by the arrow 321 by translation of the gantry 312 on a pair of tracks 324 mounted to the table 315. The probe 318 travels in the direction indicated by the arrow 327 by translation of a carriage 328 on a pair of tracks (not shown) mounted to the gantry 312. The probe 318 comprises a touch probe 330 extending from a quill 333. The probe 318 travels in the direction indicated by the arrow 336 through vertical reciprocation of the quill 333 from the carriage 328.

As those in the art having the benefit of this disclosure will appreciate, there are many CNC tools that are much more sophisticated than that presented above. Some more sophisticated implementations may include a rotary table (not shown) inset on the table 312 and may include rotary motion of the probe 318 relative to the carriage 328, for example. Some other CNC tools may employ other types of touch sensors or even other types of add-on equipment.

A technician 303 is shown assisting in the operation of the milling tool 300. The milling tool 300 is examining a good 302, and more particularly, actually measuring the dimensions of the good 302. Once the good 302 is placed upon the table 312, the probe 318 is manipulated in three dimensions so that the touch probe 330 traces the contours of the good 302. This manipulation may be manual by the technician 303 using a peripheral device such as a joystick (not shown) or automatically by a utility 339 residing on the computing apparatus 106. Contact between the touch probe 318 and the good 302 can be maintained by monitoring the pressure exerted by the contact on the touch probe 318. The translations are monitored, and output to the computing apparatus 106, whereupon the utility 339 converts them into the coordinates defining the contour of the good 302.

The operation of the milling tool 300, including the translations of the probe 318 is controlled by the computer apparatus 106 through the operating system 230 executing a series of macros. Most of these macros will be conventional and will have been coded and loaded in conventional fashion. The conventional macros (not shown) were acquired from Renishaw Inc., 5277 Trillium Blvd, Hoffman Estates, Ill. 60192 USA, United States, telephone +1 847 286 9953, telefax: +1 847 286 9974. Additional information is available on their site on the World Wide Web of the Internet at http://www.renishaw.com/client/category/UKEnglish/CAT-1079.shtml.

However, the operating system also controls the probe 318 through execution of the macro 107. The macro 107 for controlling the action of the add-on equipment, i.e., the touch sensor or probe 318, is coded in accordance with the present invention as will be discussed further below. Because the macro 107 controls a probe 318, it may be referred to as “probing software” in this particular embodiment. Furthermore, it is encoded in what is known as “G-code”, which is the conventional programming language. However, this is implementation specific with reference to the NC controller 106 and may vary in alternative embodiments.

Still referring to FIG. 3, in this particular embodiment, the NC controller 106 and the computing apparatus 109 comprise a portion of a computing system 350. The computing system 350 may be any kind of computing system, e.g., a network employing a client/server architecture. Alternative embodiments may employ any of a number of topologies and architectures. For example, some embodiments may employ a peer-to-peer architecture. The invention is not limited by this aspect of the implementation.

The CAM application 112 and the postprocessor 115 are implemented in the illustrated embodiment using commercially available, off-the-shelf software. The CAM application 112 is implemented with a CAM application called NX available from UGS Corp. —formerly known as Unigraphics Solutions Inc. —at 5800 Granite Parkway, Suite 600, Plano, Tex. 75024, USA, telephone 1 972 987 3000. Additional information is available from their site on the World Wide Web of the Internet at http://www.ugs.com/index.shtml. The postprocessor 115 is implemented with a post-processor application called ICAM, available from ICAM Technologies Corporation, 21500 Nassr Street, Sainte-Anne-de-Bellevue, Quebec, Canada, H9X 4C1, telephone (514) 697-8033, telefax (514) 697-8621. Additional information is available from their site on the World Wide Web of the Internet at http://www.icam.com/. However, practically any CAM and postprocessor applications known to the art may be used in alternative embodiments.

Then CAM application 112 allows the user 352 to define “user defined events”. In accordance with the invention, the user 352 creates a user defined event for probing operations. The creation is performed graphically, through interactive “windows” or dialog boxes. The postprocessor 115 then creates the custom macro 107 to execute the probing operation of the user defined event. The illustrated embodiment employs a number of macros discussed further below that were created in accordance with the present invention. Note that not all the operations in the listed macros are available on all machines.

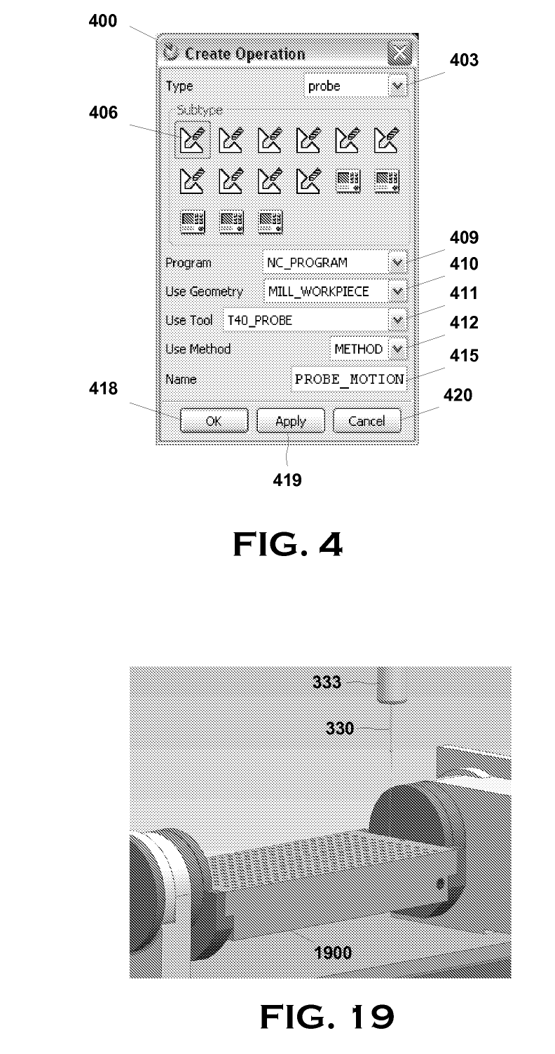

In this particular embodiment, the macro creation begins with an opening dialog box 400, entitled “Create Operation”, and shown in FIG. 4, by which a user 352 can begin the graphical programming process. The opening dialog box 400 includes a drop down menu 403 by which the user 352 can specify the type of add on equipment that is being programmed. Note that the type “probe” has been selected, and the remainder of this example will assume that a probe-type add on—e.g., the probe 318 in FIG. 3—is being programmed. However, alternative embodiments may program other types of add on equipment.

The opening dialog box 400 in this particular embodiment also includes a number of buttons 406 (only one indicated) by which the user 352 may indicate a subtype of the add on type selected in the dropdown menu 403. A set of drop down menus 409-412 permit the user to specify the kind of the program (e.g., an NC program); the nature of geometry with which the programmed add on equipment will work (e.g., a milled work piece); the particular kind of add-on equipment (e.g., a T40 probe); and the kind of method to use. The opening dialog box also includes a text box 415 in which the user 352 can name the program (e.g., “PROBE_MOTION”). A set of buttons 418-420 then permit the user to apply the selections and exit the opening dialog box 400, apply the selections and remain in the opening dialog box 400, or cancel all selections, respectively.

This opening dialog box 400 and the inclusion of the dropdown menus 409-412 are good examples of implementation specific details. In NX, the creation of a user defined event begins by defining the Program, Geometry, Tool, and Method, in which Program is the name of the NC program in which that operation is to be created (NC_PROGRAM, in the illustrated example), Geometry is the name of the coordinate system that will be used, Tool is the name of the tool that will be used, and the Method will give certain feedrates and other attributes to the created operation.

Note that techniques for generating dialog boxes are well known in all manner of arts that employ programming. This includes techniques for the creation, presentation, and operation of buttons, drop down menus, and text boxes. Note, also, that some selections within the opening dialog box 403 will define choices that may subsequently be presented to the user 352. For example, if one selects the “probe” choice from the drop down menu 403 different choices may be presented by the buttons 406 as the equipment type will define the available subtypes. These types of considerations and their management in the construction and operation of dialog boxes is also well known. Accordingly, these types of implementation specific details will not be further discussed for the sake of clarity and so as not to obscure the present invention.

Note also that whether communication for any given selection occurs by virtue of a set of buttons, a drop down menu, text entry boxes, or check boxes will be an implementation specific detail. Frequently, more than one of these alternatives may be suitable for communicating a given selection. A drop down menu might, for example, provide for a choice among a number of alternatives that just as easily may be presented using a set of buttons. The invention is not limited by these types of implementation-specific details.

In general, the motion of the probe 318, shown in FIG. 3, is controlled by selecting a safe point relative to the work piece being probed and then using engage and retract motion as well as avoidance geometry. Before creating a probing cycle, a point a safe distance away from the part, table, fixture, etc., is selected The location of this safe point will vary depending on the type of probing cycle used. (Note all probing geometry should be placed on layer 200.) After creating a probing operation, select the safe point under “Holes Geometry.” Use an engage move and retract move for safe positioning to the point selected. The default feed rate when probing is 100 ipm. Protected positioning is only active during non rapid moves and that you must use rapid moves when rotating any axis. Avoidance geometry may also be used if necessary or desirable.

More technically, probing operations in NX are actually customized drilling operations using a Standard Text Cycle called Probe. The probing motion is controlled by using avoidance geometry and engage and retract settings. A startup user defined command is used to define the probing cycle and end-of-path user commands are used to manipulate the data. All the commands for probing are manipulated within the ICAM postprocessor.

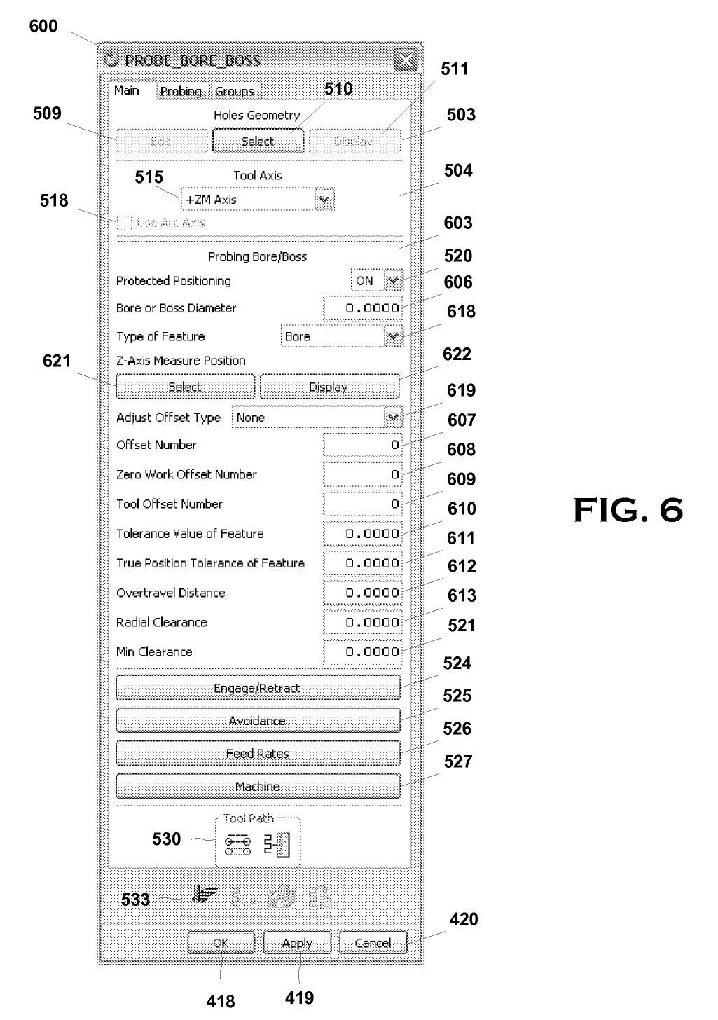

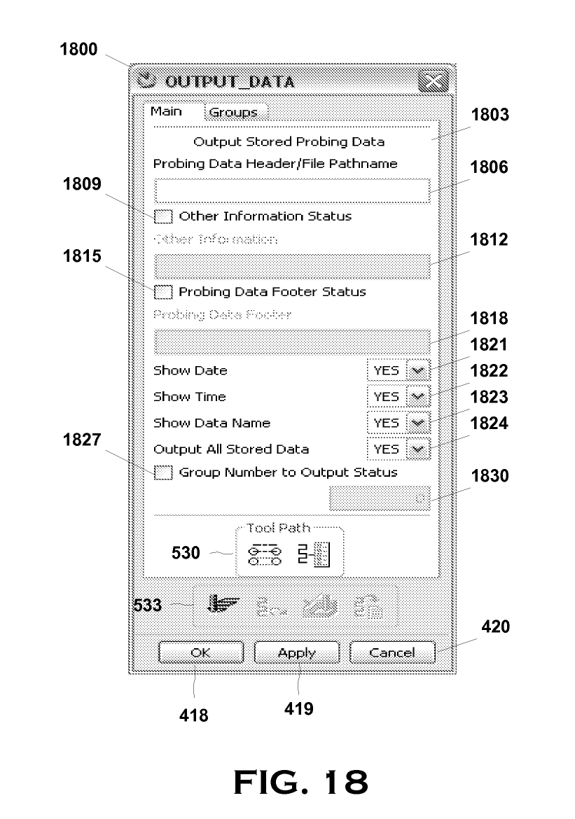

Accordingly, the programming operation then continues with a new dialog box which may be referred to as a program definition box. The content of the program definition box, the information solicited from the user 352, and the choices proffered to the user 352 will be strongly influenced, if not defined, by the choices made in the selections in the opening dialog box 400. To help illustrate some of the variation in this aspect of the implementation, FIG. 6-FIG. 18 will present several program definition boxes 600-1800, respectively. These particular programming definitions are for use in probing a work piece 1900, shown in FIG. 19.

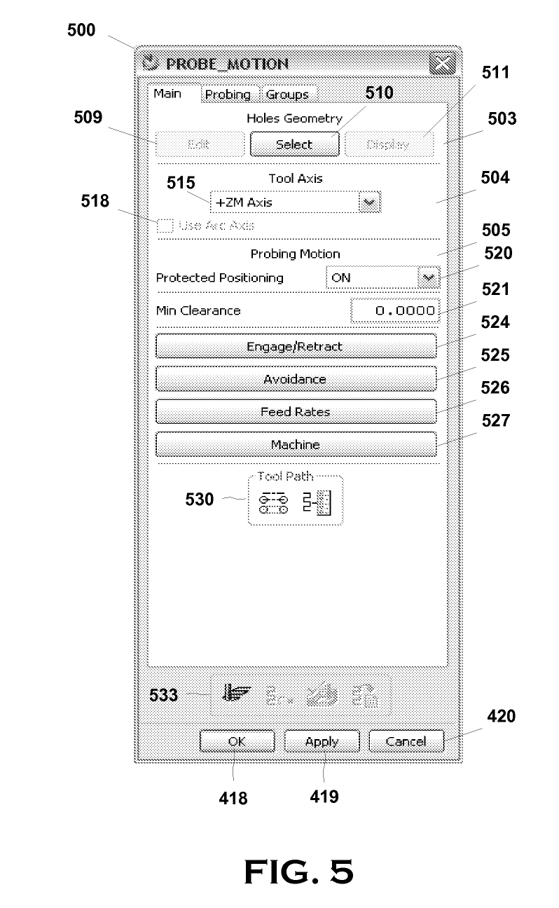

Turning now to FIG. 5, a program definition box 500 for an operation called PROBE_MOTION, which controls probe motion, is shown. The program definition box 500 presents three sections 503-505 in which the user specifies hole geometry, tool axis, and probing motion parameters, respectively. The holes geometry section 503 includes three buttons 509-511 permitting the user 352 to edit, select, or display, respectively, a point for the probe 318 and the tool axis section 504 presents a dropdown menu 515 by which the user 352 may select the correct tool axis for the movement and presents a check box 518 by which the user 352 can specify that an Arc Axis be used. Note that the Arc Axis will be unavailable for probing operations, and so the check box 518 will be inactive for probing operations.

The probing motion section 505 presents a dropdown menu 520 for selecting whether to use protected positioning. Selecting “on” will set a probe trigger flag and will not alarm out the probe if contact is made in this particular embodiment. A text box 521 is presented for entering a minimum clearance. A set of buttons 524-527 permit the user 352 to set engage and retract motion, avoidance geometry, feedrates for engage and retract motion, and add user defined events, respectively. User defined events are basically machine control statements. A “Tool Path” graphic 530 is used to change your toolpath display options. This button opens up another dialog box that gives you options on how you want to display the toolpath.

The program definition box 500 also provides a graphic indicator 533 used to generate the toolpath, replay the toolpath, verify the toolpath, and list out the toolpath as a text file. Replay shows a wireframe toolpath and verify toolpath shows a solid model toolpath that can check for collisions.

The program definition box 500 also presents several features that are common across many of the program definition boxes in FIG. 5-FIG. 18. The program definition box 500 includes, for example, the “OK”, “Apply”, and “Cancel” buttons 418-420 first seen in the opening dialog box 400 shown in FIG. 4. The holes geometry section 503, with its “Edit”, “Select”, and “Display buttons 509-14, are also found in the program definition boxes of FIG. 6-FIG. 14. So, too, is the “Tool Axis” section 504 and its dropdown menu 515 and “Use Arc Axis” checkbox 518. Still other features of various program definition boxes are also found in common across other program definition boxes. To avoid needless, cluttering repetition in this discourse that might otherwise obfuscate the invention, discussion of these common features will only be presented the first time they are encountered.

FIG. 6 shows a program definition box 600 for probing a bore or a boss. As mentioned above, the “Select” button 510 is also employed in this box, but takes on a subtly different meaning. In this program definition box, the button 510 is used to select a safe point on the expected centerline of the feature to be probed. For a bore, the position is on the z-axis to a suitable position inside the bore. For a boss, the position is on the z-axis to as suitable position above the boss. The “Probing Bore/Boss” section 603 presents a number of text entry boxes 606-613 where the user 352 can enter the nominal size of the feature, the offset number to be updated, the work offset number to be set to zero, the tool offset number to be updated, the tolerance value of the feature, the true position tolerance of the feature, the probe overtravel distance, and the radial clearance for the feature, respectively. The section 603 also presents dropdown menus 618-619 by which the user 352 can specify the feature to be probed and the adjust offset type, respectively. Finally, the section 603 also presents a set of buttons 621-622 by which the user 352 may either select or display, respectively, the z-axis measure position.

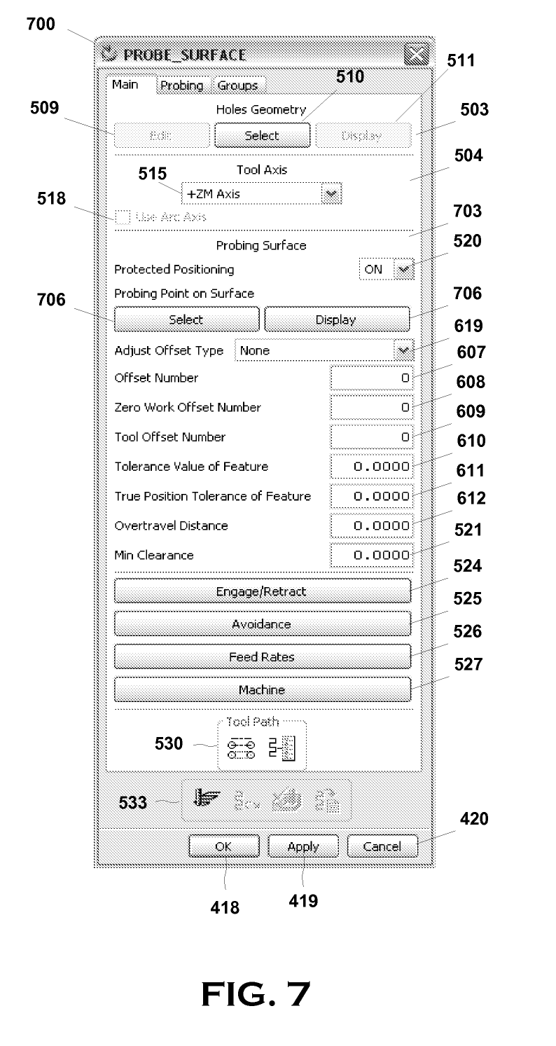

FIG. 7 presents a program definition box 700 for probing a surface. The “Select” button 510 allows the user 352 to select a safe point away from the surface but inline with the probing point on the surface. The “Probing Surface” section 703 provides a set of buttons 706-707 for selecting and displaying, respectively, a probing point on the surface that must be inline with the safe point selected in the “Holes Geometry” section 503.

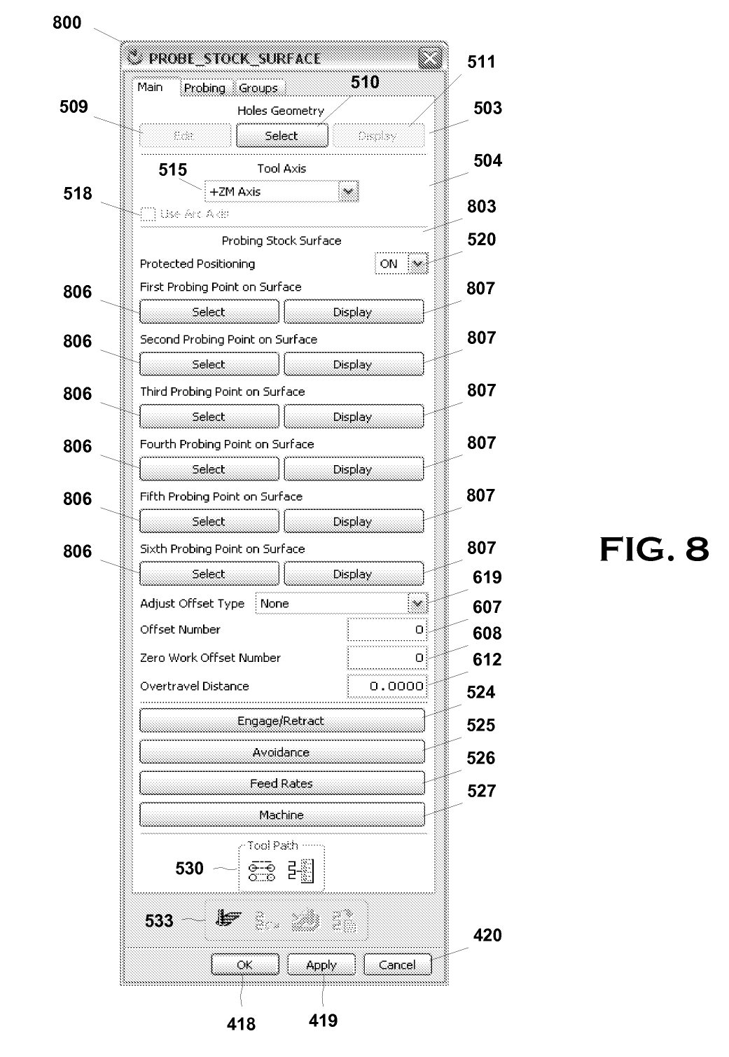

FIG. 8 presents a program definition box 800 of probing the stock surface. The “Select” button 510 allows, as in the program definition box 700 of FIG. 7, the user 352 to select a safe point away from the surface but inline with the probing point on the surface. The probing stock surface 803 presents several sets of buttons 806-807 by which the user 352 may select up to six probing points on the surface.

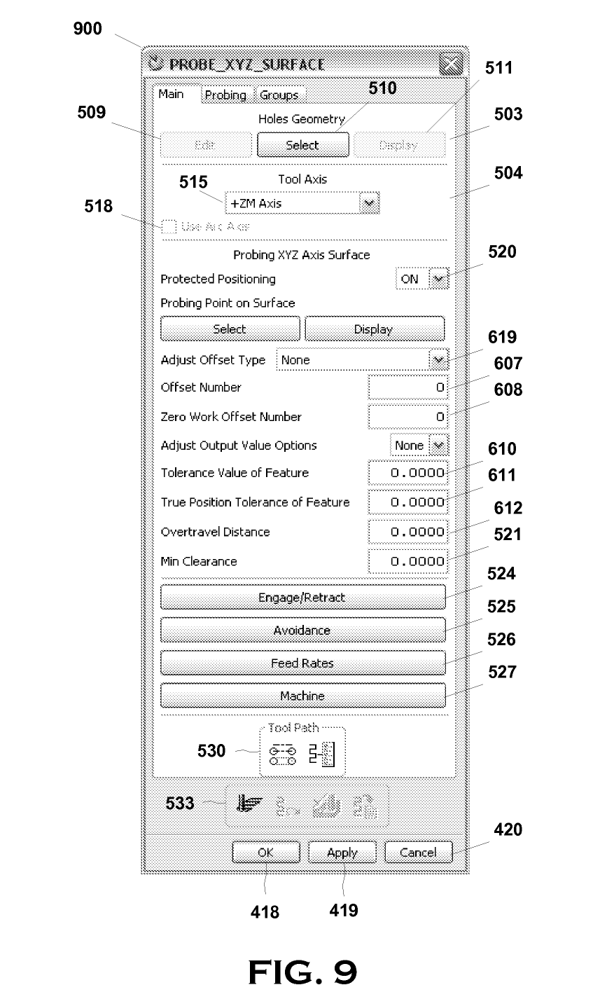

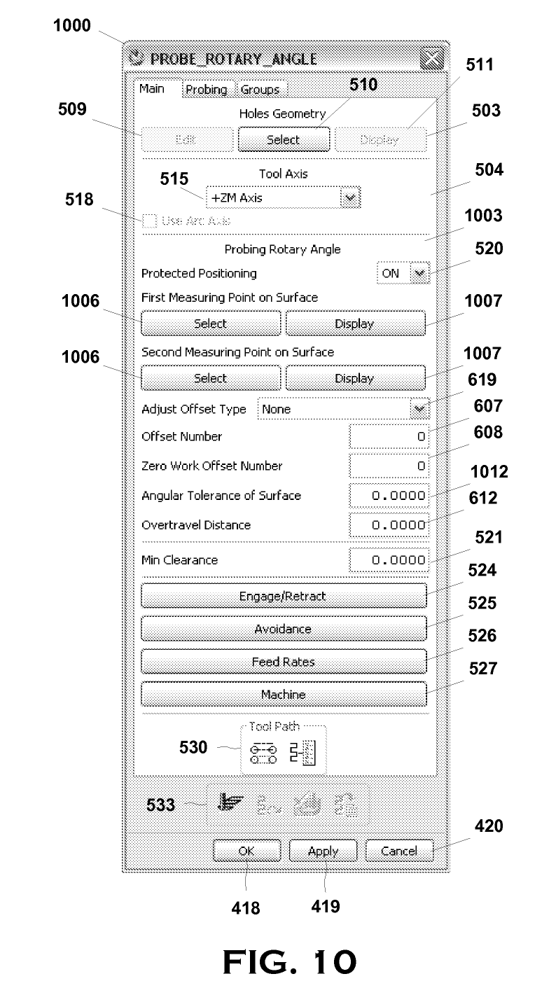

FIG. 9 presents a program definition box 900 for probing a three dimensional (i.e., XYZ) surface. The “Select” button 510 allows the user 352 to select a safe point away from the surface. The “Probing XYZ Axis Surface” section 903 presents a pair of buttons 906-907 by which the user 352 may select or display a probing point. It also presents a dropdown menu 909 by which the user 352 can select the adjust offset type.

FIG. 10 presents a program definition box 1000 for probing a rotary angle. The “Select” button 510 allows the user 352 to select a safe point away from the surface and close to the middle of the surface. The “Probing Rotary Angle” section 1003 presents a pair of buttons 1006-1007 by which the user 352 can select or display first and second measuring points on the surface. It also presents a text entry box 1012 in which the user 352 can enter the angular tolerance of the surface.

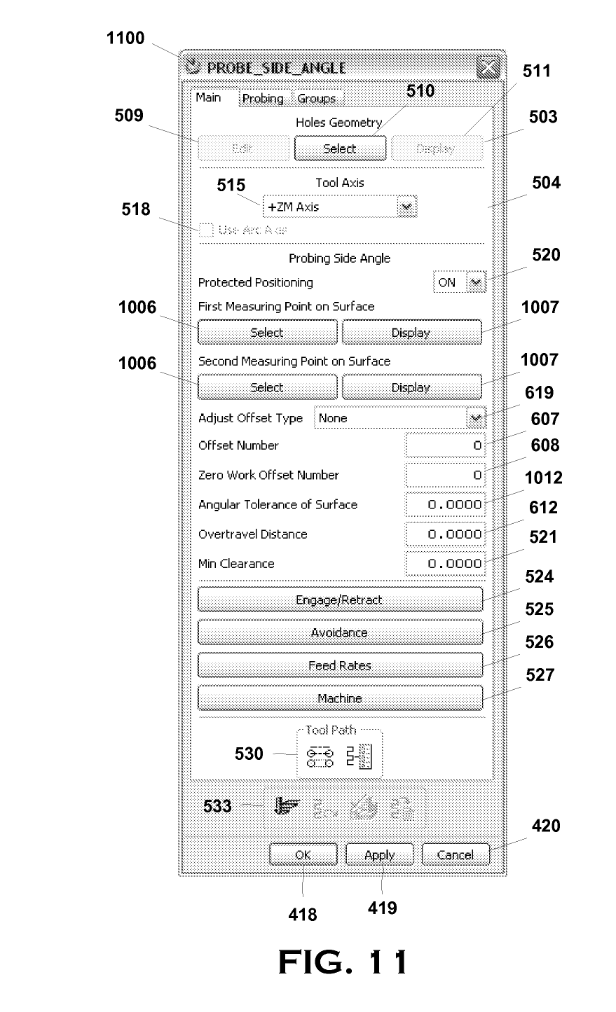

FIG. 11 presents a program definition box 1100 for probing a side angle. The “Select” button 510 allows the user 352 to select, as in the program definition box 1000 in FIG. 7, a safe point away from the surface and close to the middle of the surface.

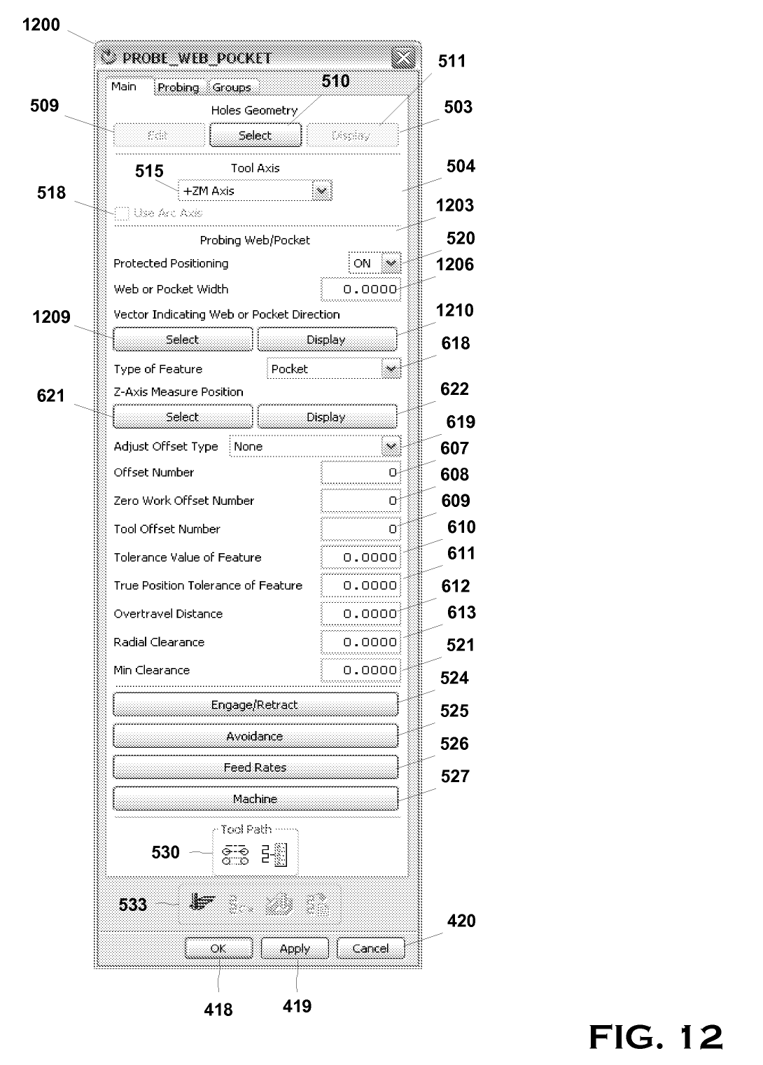

FIG. 12 presents a program definition box 1200 for probing a web pocket. The “Select” button 510 allows the user 352 to select a safe point at the expected centerline of the feature. For a pocket, this would position the z-axis to a suitable position inside the pocket. For a web, this would position the z-axis to a suitable position above the web. The “Probing Web/Pocket” section 1203 includes a text entry box 1206 in which the web or pocket width may be entered. It also presents a pair of buttons 1209-1210 by which the user 352 can select or display a vector indicating the web or pocket direction. Note that the dropdown menu 618 for selecting the type of feature indicates that a pocket has been selected, and it will also present a web for selection, as well.

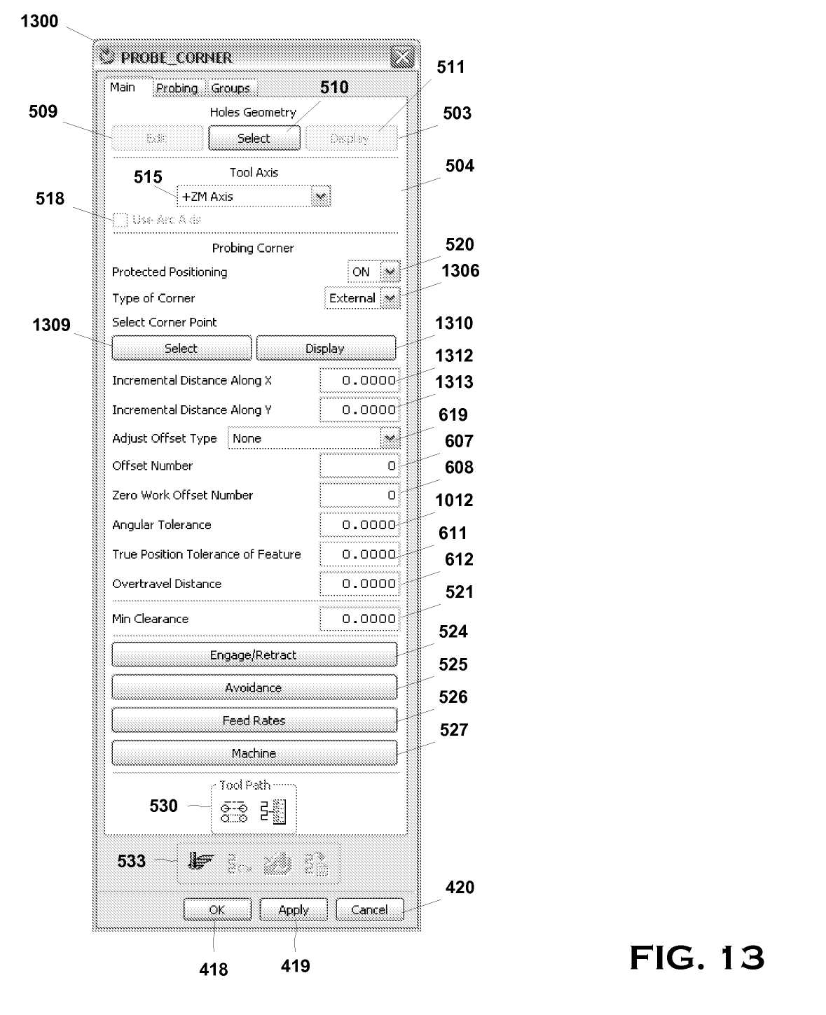

FIG. 13 presents a program definition box 1300 for probing a corner. The “Select” button 510 allows the user 352 to select a safe point away from the corner at the desired measuring height. The point should also be symmetrical to the corner. The “Probing Corner” section 1303 presents a dropdown menu 1306 to define the corner as either internal or external. It also provides a set of buttons 1309-1310 by which the user 352 can either select or display the corner point. It furthermore presents a set of text entry boxes 1312-1313 by which the user 352 may optionally set the incremental distance along the x and y axes for a second measuring position.

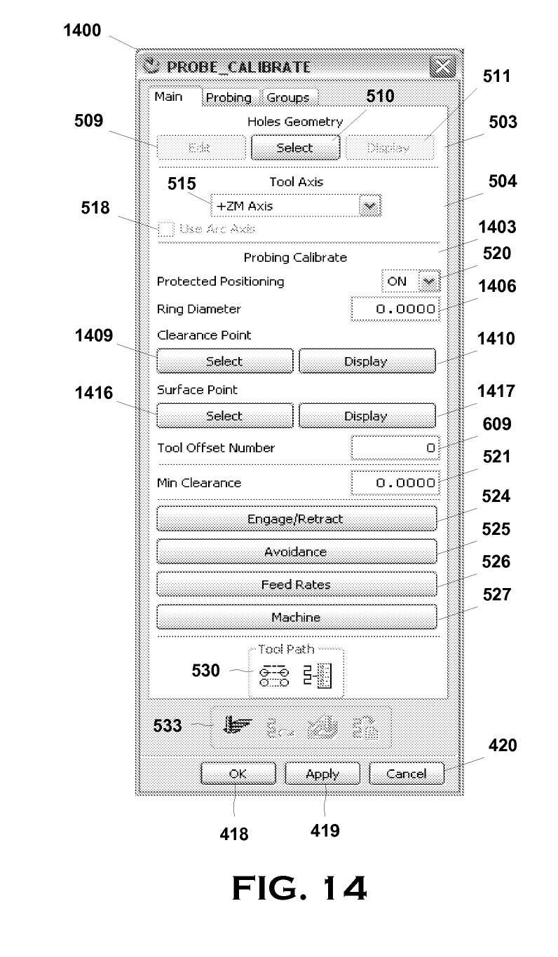

FIG. 14 presents a program definition box 1400 for calibrating a probe. The “Select” button 510 allows the user 352 to select a safe point in the center of the ring gage or calibrating bore. The “Probing Calibrate” section 1403 presents a text entry box 1406 for entering the ring diameter. It also presents a set of buttons 1409-1410 by which the user 352 may select or display a clearance point, which is required for calibrating tool length. The clearance point is above the gage for clearance to the surface point. It furthermore presents a set of buttons 1415-1416 by which the user 352 can select or display a surface point, which is also required for calibrating tool length.

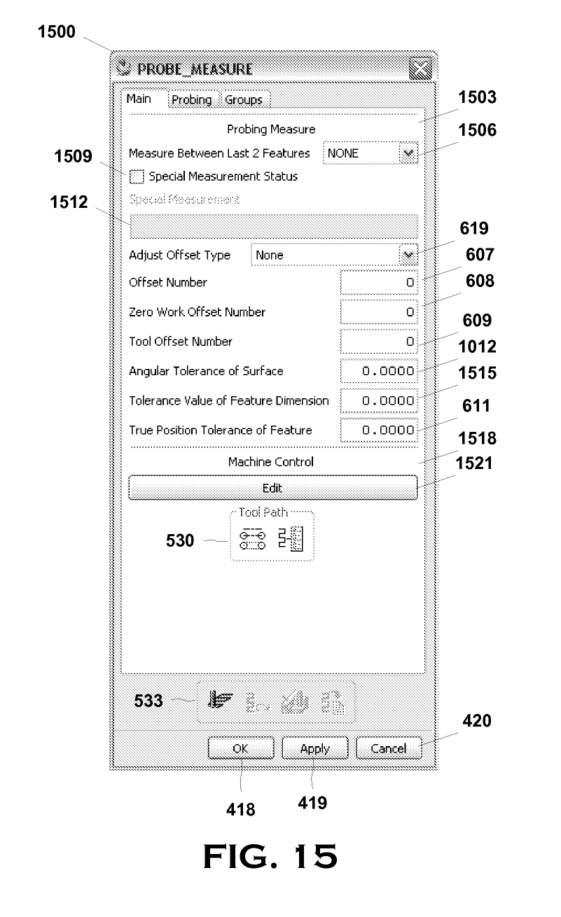

FIG. 15 presents a program definition box 1500 for an operation, PROBE_MEASURE, used to measure feature-to-feature data between the last two probe measuring cycles. To use PROBE_MEASURE, the user 352 first creates two probing operations to measure the two features using, for example, defined in the manner as some of those above. The user 352 then creates the PROBE_MEASURE operation. This operation automatically stores all the data from the first probe measuring cycle so that it can be used in conjunction with the second measuring cycle to calculate a feature-to-feature measurement. No movement is associated with the PROBE_MEASURE operation. This can be considered “cascaded” operations or conceptualized as “nested macros”.

The program definition box 1500 presents in the “Probing Measure” section 1503 presents a dropdown menu 1506 with which the user 352 can specify a “special measurement” and a checkbox 1509. In FIG. 15, “NONE” has been selected from the dropdown menu 1506, indicating that a special measurement is to be taken. It also includes a text entry box 1512 into which the user 352 can enter a code indicating what the special measurement is. It also includes a text entry box 1515 in which the user 352 can enter the tolerance value for a feature dimension. The “Machine Control” section 1518 is the same as the machine box in the other boxes and includes a button 1221 that permits the user 352 to add user defined events.

A special measurement is an implementation specific detail. A “special measurement” in this particular embodiment is a measurement that is not common but may happen more than once. As was noted above, in the embodiment illustrated in FIG. 3, the milling tool 300 is a Mazak Integrex CNC tool. For the Integrex, a special measurement code has been developed to measure the center and diameter of a shaft. This calculation requires that four vertical surface measurements are made on the outer diameter (“OD”) of the shaft. The measurements are made at C=0, 90, 180, and 270, where C refers to the C-axis. The C-axis is the rotary axis about the Z-axis, and C-axis values are in degrees. The X-position of each measurement must be stored as a variable. The code is typed as shown below.

### ‘CENTER4-VARIABLE 1,VARIABLE2,VARIABLE3,VARIABLE4’

where,

CENTER4—indicates the correct measurement code name

VARIABLE1 indicates the variable name for the X-position at C=0;

VARIABLE2 indicates the variable name for the X-position at C=90;

VARIABLE3 indicates the variable name for the X-position at C=180; and

VARIABLE4 indicates the variable name for the X-position at C=270.

### Note that variable names are separated by commas.

Another special measurement code available on all machines is used to calculate the average from 4 surface points. This would be used if establishing a datum surface. The code must be typed as shown below.

### ‘SURF4-Y,VARIABLE 1,VARIABLE2,VARIABLE3,VARIABLE4’

where,

SURF4—indicates the correct measurement code name;

Y—indicates the surface of points (use X or Y or Z);

VARIABLE1 indicates the variable name for the first variable point;

VARIABLE2 indicates the variable name for the second variable point;

VARIABLE3 indicates the variable name for the third variable point; and

VARIABLE4 indicates the variable name for the fourth variable point.

### The calculated average value is stored in the Feature Size (#138) variable.

Still another special measurement code available on all machines is used to calculate the midpoint from two points. This would be used if establishing a datum between two surfaces. The code must be typed as shown below.

### ‘MID-X,VARIABLE1,VARIABLE2’

where,

MID—indicates the correct measurement code name;

X—indicates the surface of points (use X or Y or Z);

VARIABLE1 indicates the variable name for the first variable point; and

VARIABLE2 indicates the variable name for the second variable point.

### The calculated value is stored in the Feature Size (#138) variable.

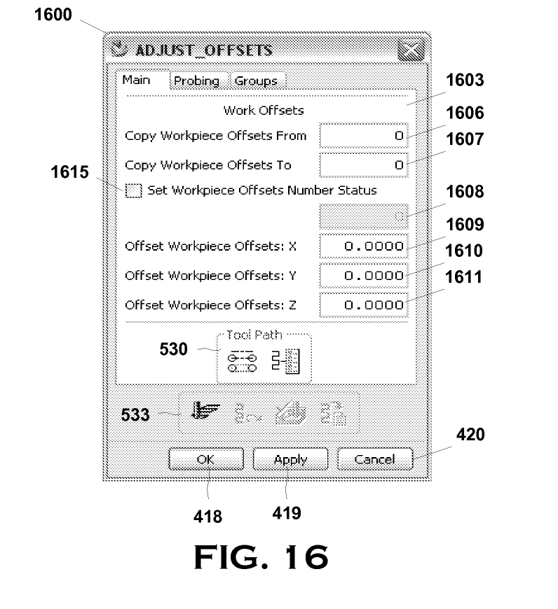

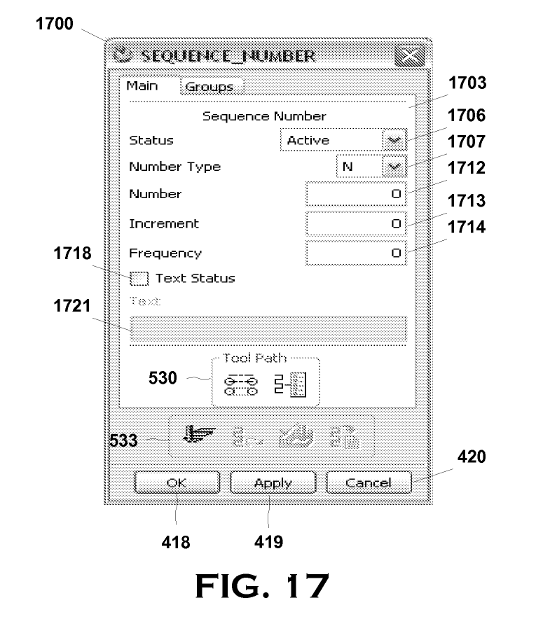

FIG. 16 and FIG. 17 are to define operations that perform additional tasks unrelated to probing. These operations give the machine decision making capabilities meaning the probe can touch something or not. If something is there then the machine does whatever it is programmed to do. If something is not there then the machine does something else. With this capability, the machine can run only specific parts of a program. The operation defined in FIG. 17 is used to number each line of a program. Once each line is numbered, one can jump to certain line numbers. The operation defined in FIG. 16 is used to manipulate the machining origin. If one measures a part and it is thicker than it is suppose to be, one can raise the origin by adjusting the offset.

FIG. 16 presents a program definition box 1600 for an operation to adjust the work piece offsets as needed. The “Work Offsets” section 1603 presents a set of text boxes 1606-1611 in which the user 352 can enter the offset number to copy values from, enter offset number to copy values to, enter offset number to set, adjust current offsets along X, adjust current offsets along Y, and adjust current offsets along Z, respectively. It also present a checkbox 1615 by which the user 352 can indicate the set work piece offsets number status.

FIG. 17 presents a program definition box 1700 for an operation used to set sequence numbers when a logical statement is used to GOTO a certain sequence number. The “Sequence Number” section 1703 presents a set of dropdown menus 1706-1707 by which the user can select the status (e.g., “Active” or “Inactive”) and the number type of N (indicates the letter before the line number). It also presents a set of text entry boxes 1712-1714 for defining the line number, increment of numbers, and frequency of numbers. It also presents a checkbox 1718 and an associated text entry box 1721 by which the user 352 can add additional text to the operation.

FIG. 18 presents a program definition box 1800 that is used for controlling the output of data. The output data operation defines three places to insert text within the output of the data. The first place is in the Probing Data Header/File Pathname. Text in this field would be like a name for the data or the filename. The second place is in the Other Information field. Text here would follow the previous box. It could be any additional information like part number. The third place is in the Probing Data Footer. This text would be outputted after the data (at the end). These text fields are used to search for data within a text file that may have hundreds of sets of data.

Thus, the program definition box 1800 presents a single section 1803 including a text entry box 1806 in which the user 352 can enter the header for the data to be output. It also includes a checkbox 1809 for indicating whether more information and a text entry box 1812 where a footer may be entered. It furthermore includes a checkbox 1815, with an associated text entry box 1818 in which the user 352 can indicate whether additional information is to be entered and where it can be entered. A set of dropdown menus 1821-1824 by which the user 352 can indicate whether to show date, time and name of data collected as well as whether to output all data or only selected data, respectively. Finally, it also includes a checkbox 1827 and an associated text entry box 1830

Each of the probing dialog boxes have three tabbed menus. The discussion above regarding FIG. 5-FIG. 18 pertains to the “Main” tabbed menu, in which the user 352 defines the parameters of the probing operation. The “Groups” tab is where the user 352 selects and edits the tool, the method, and the geometry used for the operation. The “Probing” tabbed menu permits adjustment of the work offsets, storage of the data collected from the probing operation, and insertion of a logical statement.

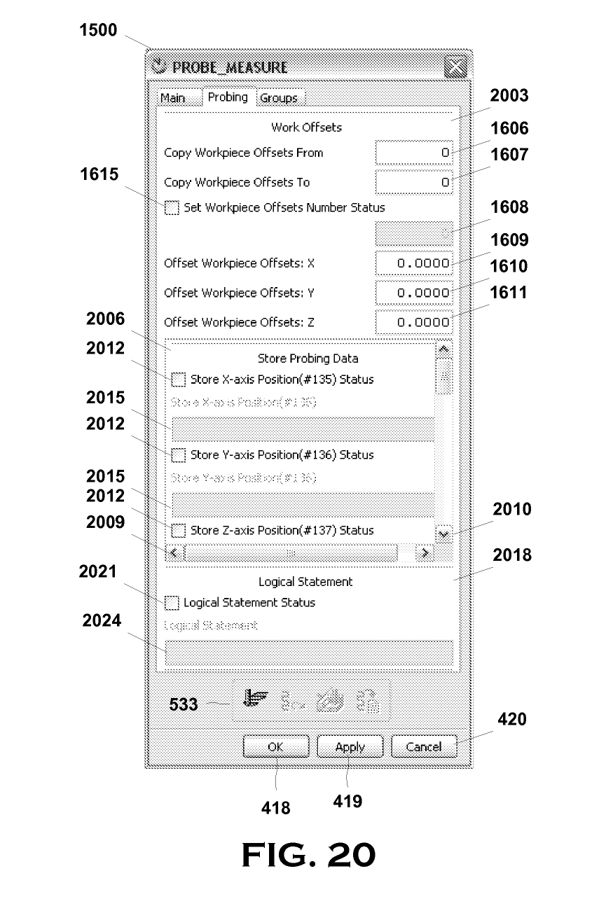

The “Groups” and “Probing” tabs operate similarly to the “Main” tab. FIG. 20 presents the “Probing” tabbed menu for the program definition box 1500, first shown in FIG. 15. Note that the “Work Offsets” section 1800 duplicates the data entry for the program definition box 1600 shown in FIG. 16. The “Store Probing Data” section 2006 includes a pair of slide bars 2009-2010 by which the user 352 can control the display to reveal a set of checkboxes 2012 and associated text entry boxes 2015. The user 352 can use the checkboxes 2012 and text entry boxes 2015 to indicate whether data along certain axes is to be stored and, if so, where. The “Logical Statement” section 2018 includes a checkbox 2021 and text entry box 2024 in which the user 352 can indicate whether a logical statement is to be entered and, if so, what it is. The other program definition boxes 500-1400 and 1600 presented in FIG. 5-FIG. 16 will have similar “Probing” tabbed menus.

The illustrated embodiment also has developed a particular notation that may be used to indicate what data that is being stored is to be output at a later time. The syntax employs a number [0-9] followed by // before the data name, but still within quotes, such as ‘0//X-AXIS POSITION FOR DATUM-A-’ or ‘2//Y-AXIS POSITION FOR DATUM-B-’. The number ‘0’ indicates that the data value will not be outputted. Any other number between 1 and 9 indicates a specific group number to output.

Stored data may also need to be manipulated using machine function statements. To create machine function statements in the illustrated embodiment, type the statement in the Logical Statement text entry box 2025, and use the stored data name to reference the stored data within the statement. For example, the logical statement ‘IF [POINT 6 X-ERROR GT 0.5] GOTO 1’, assuming that POINT 6 X-ERROR was stored as a variable earlier, will replace the variable name with the correct variable number. A Sequence Number operation to insert N1 at the correct location in the program, that is, the sequence number operation can be used to specify line numbers so that the program can jump to the correct line.

The present invention, in the illustrated embodiment, comprises a method and apparatus centered around software that will allow probing software (e.g., NC code) to be created by a computer aided manufacturing (“CAM”) system (e.g., Unigraphics) in conjunction with a post processor (e.g., ICAM). Dialog boxes are created within Unigraphics so that simulated probing could be done. The dialog boxes obtain all necessary information for the probing operation. The postprocessor (ICAM) takes the data from Unigraphics and manipulates it to output the correct probing commands for the specific machine.

Thus, in one aspect, the current invention includes an apparatus 100, shown in FIG. 1, comprising a computing apparatus 109 and a computer numerical code tool 103. A CAM manufacturing software application 112 and a postprocessor 115 reside on the computing apparatus 109. The computer numerical code tool 103 includes an add-on sensor 108 and a NC controller 103. The NC controller includes a software directive (e.g., the macro 108) for the add-on sensor 108 received from the application 112 via the postprocessor 115.

In a second aspect, the current invention includes a numerical control controller 106, shown in FIG. 2A, comprising a processor 205, a bus system 215, a storage 210, and a macro 108. The storage electronically communicates with the processor 205 over the bus system 215. The macro 108 resides on the storage 210. When executed by the processor 205, the macro controls an add-on sensor 108, the macro 108 having been coded from within a CAM software application 112 and having been transferred therefrom to the numerical control controller 106 through a postprocessor 115.

A third aspect of the illustrated embodiment of the present invention is illustrated in FIG. 21. The method 2100 begins by accessing (at 2110) a computer-aided manufacturing software application. The method 2100 then continues by coding (at 2120) a macro from within the accessed application for a numerical control controller for controlling an add-on sensor.

The integration presented by the invention as disclosed above allowed probing NC code to now be created by the CAM system which dramatically reduces probing programming time. It some embodiments, the present invention yields an estimated 70% reduction in programming time. It also provides verification within the CAM system, which allows graphical proofing of probing movements which reduces machine proofing time and costly crashes. The ease of probing programming gives the capability to easily add probing to any part to reduce setup time and machining time. It also allows quick part inspection to verify tight tolerance parts are machined correctly, and allows any NC programmer to quickly learn probing. The specialized probing macros furthermore give the ability to confidently and easily make setup offsets correctly as well as perform complicated geometric calculations. Note that not all embodiments will necessarily exhibit all these characteristics.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
accessing a computer-aided manufacturing software application; and
coding a macro from within the accessed application for a numerical control controller for an controlling an add-on sensor.

2. The method of claim 1, further comprising transferring the macro to the numerical control controller through a postprocessor.

3. The method of claim 2, further comprising executing the macro by the numerical control controller.

4. An apparatus, comprising:
a computer numerical code tool, including:
an add-on sensor; and
a numerical control controller including a software directive for the add-on sensor received from the application via the postprocessor;
a computing apparatus on which resides;
a postprocessor; and
a computer-aided manufacturing software application residing on the computing apparatus from within which a user may program a macro to be implemented through the processor to control the add-on sensor.

5. The apparatus of claim 4, wherein the postprocessor resides on the computing apparatus.

6. The apparatus of claim 4, wherein the computing apparatus comprises a portion of a computing system.

7. The apparatus of claim 6, wherein the computing system includes a second computing apparatus on which the postprocessor resides.

8. The apparatus of claim 6, wherein the numerical control controller comprises a portion of the computing system.

9. A numerical control controller, comprising:
a processor;
a bus system;
a storage electronically communicating with the processor over the bus system; and
a macro residing on the storage that, when executed by the processor, controls an add-on sensor, the macro having been coded from within a computer-aided manufacturing software application and having been transferred therefrom to the numerical control controller through a postprocessor.
